(19) United States
(12) Patent Application Publication
(10) Pub. No.: US 2013/0262060 A1
(43) Pub. Date: Oct. 3, 2013

(54) SYSTEMS AND METHODS FOR MANAGING AN INFRASTRUCTURE USING A VIRTUAL MODELING PLATFORM

(71) Applicant: GENERAL ELECTRIC COMPANY, Schenectady, NY (US)

(72) Inventor: Mitchell Kent Higashi, Waukesha, WI (US)

(73) Assignee: General Electric Company, Schenectady, NY (US)

(21) Appl. No.: 13/837,131

(22) Filed: Mar. 15, 2013

(30) Foreign Application Priority Data
Mar. 29, 2012 (IN) 1216/CHE/2012

(51) Int. Cl. G06F 17/50

(52) U.S. Cl. CPC G06F 17/5009
USPC 703/6

(57) ABSTRACT

Systems and methods for virtual modeling, mapping, and simulation are disclosed. An example computing system to manage an infrastructure using a virtual modeling platform is disclosed. The computing system dynamically allocates multiple resources in a location that represents a location within the virtual environment. The multiple resources may be associated with an infrastructure for example, a healthcare infrastructure. Then the computing system determines one or more of multiple health metrics associated with a number of people, multiple resource metrics and multiple economic metrics based on the allocated resources.

### CROSS-REFERENCE TO RELATED APPLICATIONS

This application claims the benefit of priority of Indian Patent Application No. 1216/CHE/2012, filed on Mar. 29, 2012, which is hereby incorporated herein by reference in its entirety.

### TECHNICAL FIELD

The subject matter disclosed herein relates to managing an infrastructure in a virtual environment. More specifically relates to, a system and method for managing an infrastructure using a virtual modeling platform.

### BACKGROUND OF THE INVENTION

Growth in population is constant throughout the world even though controlling measures are being taken. Various types of resources are required to satisfy the needs of the population thus efficient planning and allocation of resources is becoming increasingly important. The resources can include health resources, energy resources and water resources. The resources need to be allocated in an efficient manner based on various parameters such as, population distribution in an area, distance between resource allocated areas, demographic details of an area, etc.

For example, healthcare authorities may plan to set up healthcare resources such as, hospitals having healthcare equipments and beds for treating patients in a region. In order to plan and set up these healthcare resources various factors need to be considered such as, population distribution, mortality rate, disease prevalence, demographic details, types of diseases, etc. Currently these parameters are being considered to plan and set up the healthcare resources in the region however determining an optimal combination of the health resources that can serve the needs of the population needs to be achieved. This optimal combination is required in order to satisfy health needs of the population without wastage and inefficient utilization of resources which can lead to loss of expenditure on setting up the resources.

Therefore there is a need for a system for managing an infrastructure efficiently in a virtual modeling environment.

### BRIEF DESCRIPTION OF THE INVENTION

The above-mentioned shortcomings, disadvantages and problems are addressed herein which will be understood by reading and understanding the following specification.

In an embodiment, a computing system to manage an infrastructure using a virtual modeling platform is disclosed. The computing system includes a memory to store multiple demographic parameters and multiple health parameters associated with a number of people in a location. The computing system also includes a processor for dynamically allocating multiple resources in a region representing the location within a virtual environment, wherein the multiple resources is associated with an infrastructure for healthcare. The multiple resources may be associated with an infrastructure for example, a healthcare infrastructure. Then the computing system determines at least one health metric of multiple health metrics associated with a number of people, multiple resource metrics and multiple economic metrics based on the allocated resources.

In another embodiment, a system for managing an infrastructure using a virtual modeling platform is disclosed. The system includes a virtual environment comprising multiple agents in a location. The multiple agents represent a number of people present in a location. The system includes a resource allocator for dynamically allocating multiple resources associated with healthcare in the location. Thereafter a comparator engine receives multiple demographic parameters and multiple health parameters associated with the multiple agents in the location. The comparator engine then determines multiple health metrics associated with a number of people, multiple resource metrics and multiple economic metrics based on the allocated resources. The multiple health metrics and the multiple economic metrics facilitate in managing the infrastructure in the location.

In still another embodiment, a method of managing an infrastructure using a virtual modeling platform is disclosed. The method involves receiving multiple demographic parameters and multiple health parameters associated with multiple agents. Thereafter multiple resources are dynamically allocated in a in a region representing the location within a virtual environment. The virtual environment comprises the multiple agents in the location. The multiple agents represent a number of people present in the location. Subsequently, one or more of multiple health metrics associated with number of people, multiple resource metrics and multiple economic metrics are determined based on the allocated resources, the multiple demographic parameters and the multiple health parameters. The multiple health metrics and the multiple economic metrics facilitate in managing the infrastructure for healthcare in the location.

Various other features, objects, and advantages of the invention will be made apparent to those skilled in the art from the accompanying drawings and detailed description thereof.

### BRIEF DESCRIPTION OF THE DRAWINGS

FIG. 1 illustrates an exemplary operating environment for the present invention in accordance with an embodiment;

FIG. 2 illustrates a computing system for managing an infrastructure in a virtual modeling platform in accordance with an embodiment;

FIG. 3 illustrates a system for managing an infrastructure in a virtual modeling platform in accordance with an embodiment;

FIGS. 4-10 illustrate an exemplary user interface for managing an infrastructure in a virtual modeling platform in accordance with an embodiment; and

FIG. 11 illustrates a flowchart of a method of managing an infrastructure in a virtual modeling platform in accordance with an embodiment.

FIG. 12 illustrates a flowchart of a method of virtual modeling of one or more resources at a location in accordance with an embodiment.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in an embodiment, at least one of the elements is hereby expressly defined to include a tangible medium such as a memory, DVD, CD, BLU-RAY®, etc., storing the software and/or firmware.

As discussed in detail below, embodiments of the invention include a system and a method for managing an infrastructure using a virtual modeling platform. The system includes at least on memory and at least one processor. Multiple demographic parameters and multiple health parameters associated with a number of people in a region are stored in the virtual modeling platform. The region represents a location in the virtual environment. The at least one processor initially allocates multiple resources in this region. The multiple resources may be associated with a healthcare infrastructure. Thereafter the at least one processor determines at least one health metric associated with a number of people, multiple resource metrics and multiple economic metrics based on allocated resources.

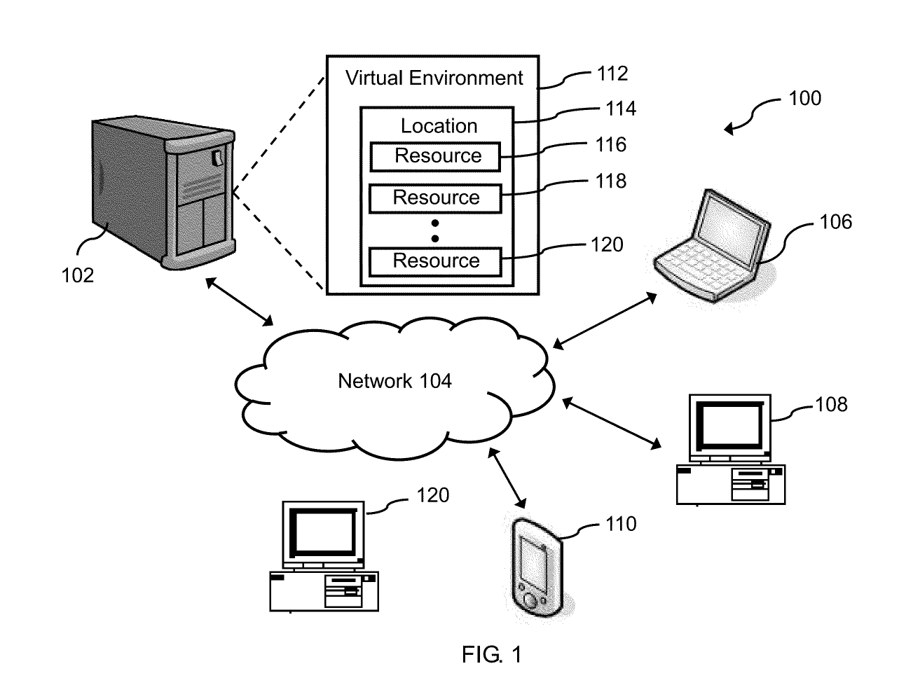

FIG. 1 illustrates an exemplary operating environment 100 for the present invention in accordance with an embodiment. The operating environment 100 enables a user to manage an infrastructure in a virtual environment. The infrastructure in a location can be managed by planning and allocation of resources within the location. The virtual environment enables the user to plan and allocate resources in a virtual region representing the location needing the infrastructure to satisfy the needs of people. Thus the virtual environment facilitates planning the allocation of resources prior to setting up the infrastructure. The operating environment 100 may include a server 102 connected to multiple user devices over a network 104. The multiple user devices may include a user device 106, a user device 108 and a user device 110. The multiple user devices may include for example but are not limited to, a computing device, a laptop and a mobile device. The network 104 may include for example but are not limited to, Local Area Network (LAN), Wireless LAN (WLAN), Wide Area Network (WAN), Metropolitan Area Network (MAN), Wireless WAN, an any Wired or Wireless Networks.

As depicted in FIG. 1, the server 102 may include a virtual environment 112 for managing resources in a location. The resources may need to be allocated in the desired location by a user for setting up an infrastructure for satisfying the needs of population in the location. The virtual environment 112 includes a region 114 that virtually represents the desired location and the population (not shown in FIG. 1). A user device of the multiple user devices may be used to allocate resources such as, a resource 116, a resource 118 and a resource 120 in the region 114. For example, a user may use the user device 106 to plan and allocate resources in the location. Similarly other users may use the user device 108 and the user device 110 to allocate resources in their desired location. The resources may include for example but are not limited to, healthcare resources, energy resources, water resources and power resources. Now considering an example where healthcare infrastructure needs to be setup in a target region for addressing healthcare needs of population in the region, a user can plan and setup required healthcare resources and other resources in a virtual environment such as, the virtual environment 112. The user may allocate the healthcare resources such as, hospitals, healthcare equipments, beds, etc. in various locations within a virtual region representing the target region. These healthcare resources may need support of power and water resources for their functioning. The energy and power resources may include for example but not limited to a power grid and a generator. Further the water resources may include any source that supplies water. Thus the user will be able to simulate the healthcare infrastructure in the target region to determine an optimal allocation of healthcare resources, water resources and power resources prior to establishing the infrastructure.

In an embodiment, a user device 122 present in the operating environment 100 may enable a user to plan and allocate resources in a virtual environment. In this case the user device 122 may be a standalone system that does not communicate with the server 102 for enabling the user to allocate the resources for managing an infrastructure. It should be appreciated that the operating environment 100 is being described in accordance with an embodiment, and that other configurations may be envisioned.

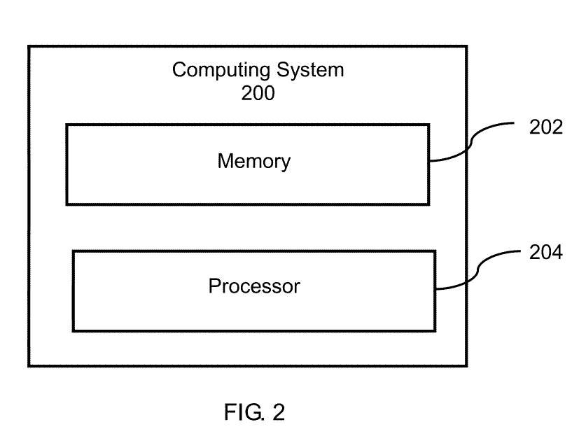

Referring now to FIG. 2, a computing system 200 for managing an infrastructure in a virtual modeling platform in accordance with an embodiment is disclosed. The virtual modeling platform provides a virtual environment having a region. The region represents a location where resources such as, healthcare resources need to be allocated. In an embodiment the region and a number of people present in the region may be presented within the virtual environment by computing system 200 based on user inputs and multiple parameters. The user inputs may include characteristics associated with the people. The characteristics may include but are not limited to, a boundary associated with a person, behavioral information associated with the person and the environment where the person is located, a state associated with each person that varies over time. The behavioral information may include but not limited to interaction of the person with other people, and social interacting capability of the person. The state of the person may include a health condition of the person such as a person with heart disease. Further the multiple parameters may include multiple demographic parameters and multiple health parameters associated with the location. The multiple demographic parameters may include but are not limited to, cost, income distribution of population, population density, productivity of existing resources, gender distribution, race, age distribution, disabilities of population, employment status, Gross Domestic Product (GDP) of the region, geographic size of the location, job status, population size, number of households, number of working days, holidays, and number of vulnerable persons in households. The multiple health parameters may include for example but are not limited to, number of deaths, life expectancy, health states of people, healthcare facilities available presently, number of accessible health experts, incidence of health hazards, number of people likely to require treatment, lack of clean water and proper sanitation, number and types of health equipments, service schedule for health equipments, average length of stay of patients in hospital, number of surgeries, quality of remaining life-years, operating and number of health procedures per day, and total hours of work by health resources. The multiple health parameters and the multiple demographic parameters may be obtained from different sources such as, Organization of Economic Co-operation and Development (OECD), World Health Organization (WHO), American Society of Radiologic Technologists (ASRT), other organizations and data sources known in the art.

The computing system 200 includes at least one memory such as, a memory 202 that may store the characteristics, the multiple health parameters and the multiple demographic parameters associated with the number of people. At least one processor such as, a processor 204 present in the computing system 200 dynamically allocates multiple resources in the region within the virtual environment. These resources allocated may be associated with an infrastructure for healthcare. The multiple resources may include but are not limited to hospitals, healthcare equipments, beds, doctors, nurses, health experts, water sources and energy sources. For example, an infrastructure for healthcare created in a state may include a number of hospitals. Each hospital may include beds, doctors, health experts, water resources and energy resources for supporting the hospital. The energy resource may be a power grid located in the state for supplying power to all the hospitals.

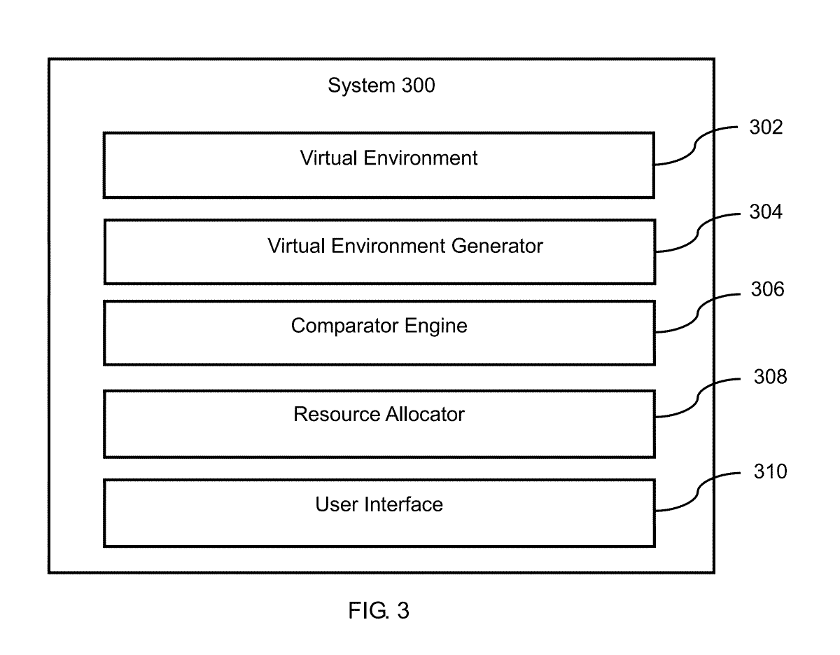

In an embodiment, the computing system 200 may allocate the multiple resources to the region in one or more resource combinations. The one or more processors may define the one or more resource combinations based on user inputs. Each resource combination may include one or more resources of the multiple resources. A resource combination may be different from another resource combination. In a non-limiting example, a resource combination may include a hospital having fifty beds, five doctors and ten healthcare equipments placed in a particular location. Another resource combination may include two hospitals having hundred beds, ten doctors and twenty healthcare equipments. In an embodiment the at least one processor may select the multiple resources to be allocated from a set of resources. In an embodiment the multiple resources are selected based on a user input. The set of resources may be the resources that are available in the virtual environment. The set of resources may include a number of healthcare resources, energy resources and water resources. In an embodiment, the set of resources may be pre-stored in the at least one memory of the computing system 200. The process of selecting the multiple resources is explained in detail in conjunction with FIG. 3 and FIGS. 4-10.

Once the multiple resources are allocated, the at least one processor determines at least one health metric of a number of health metrics associated with a number of people, multiple resource metrics and multiple economic metrics. The multiple health metrics, the multiple resource metrics and the multiple economic metrics are determined based on the allocated resources, and the multiple health parameters and the multiple economic metrics. The multiple health metrics may include for example but are not limited to, all-cause mortality, disability, quality-adjusted life-year (QALY), disability-adjusted life year (DALY), years lived with disability (YLD), disease prevalence, disease incidence accurate diagnosis and patient to health expert ratio. A health metric such as, patient to health expert ratio indicates the level of accessibility of health resources to the number of people. The patient to health expert ratio may be determined using the below expression:

Patient to health expert ratio=Number of health providers/Number of people×1000

The above expression indicates that the patient to health expert ratio is calculated based on allocated resources such as, the number of health experts and the number of people or patients.

Another health metric for example QALY may indicate the quality and quantity of life generated by the multiple allocated resources. This metric may be calculated based on health metrics of the multiple health metrics such as, life expectancy and a measure of quality of remaining life-years. QALY is determined by an arithmetic product of life expectancy and measure of quality of remaining life-years.

The multiple resource metrics may include for example but are not limited to, numbers of jobs created, personnel capacity, number of surgeries, annual number of patient discharges and resource productivity. For example, a resource metric such as resource productivity may be determined by the processor 204 using a demographic parameter and total number of hours of work of healthcare resources. The demographic parameter may be GDP that indicates a volume of output representing services provided by the healthcare resources. Now in case of the multiple economic metrics, these metrics may include for example but are not limited to, unemployment, units of equipment, training capacity, operating expense, investment cost, return of investment (ROI), net revenue per patient and cost effectiveness. An economic metric for example, ROI may be calculated by the processor 204 based on a gain from investment of one or more resources allocated in a region within a virtual environment, and cost of investment of the one or more allocated resources. Thus ROI may be calculated using the following expression:

ROI=(Gain from Investment−Cost of Investment)/Cost of Investment

Another economic metric such as cost effectiveness is a form of economic analysis that compares the relative costs and outcomes of two or more courses of action. The cost effectiveness may be expressed in the form of Incremental Cost-effectiveness Ratio (ICER) value which is defined as the ratio of a change in costs of a therapeutic intervention or a diagnostic procedure compared to an alternative to the change in effects of the intervention. The ICER may be determined using the following expression:

ICER=(Cost of an intervention procedure A−Cost of an intervention procedure B)/(Benefit of an intervention procedure A−Benefit of an intervention procedure B)

The multiple health metrics, the multiple resource metrics and the multiple economic metrics may be determined over a predefined time period. In a non-limiting example, one or more resources may be allocated in a region and then a health metric, a resource metric and an economic metric may be forecasted or predicted over a time period of 15 years. In an embodiment the predefined time period may be defined by a user input. This is explained in detail in conjunction with FIG. 3.

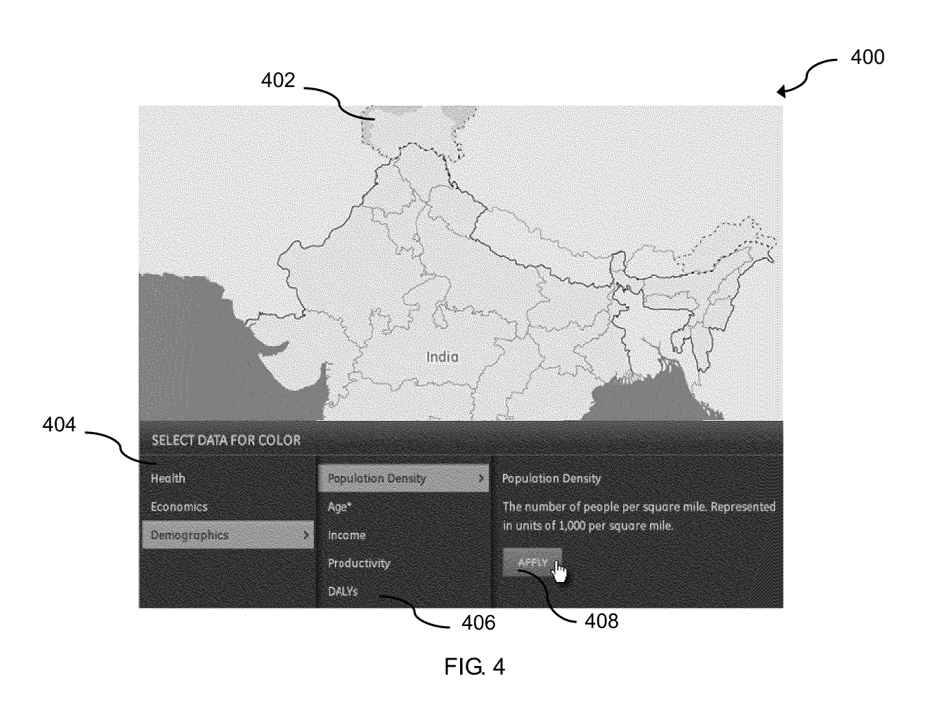

Now referring back to the embodiment wherein the multiple resources may be allocated as the one or more resource combinations, the one or more processors determine one or more health metrics, a number of economic metrics and a number of resource metrics associated with each resource combination. Subsequently, the at least one processor compares one or more health metrics, one or more economic metrics and one or more resource metrics associated with each resource combination with one or more health metrics, one or more economic metrics and one or more resource metrics associated with another resource combination. This comparative metrics analysis is then presented to the user by the computing system 200. For example, a comparison of metrics associated with two resource combination may be presented in a graphical form. However other techniques may be used to present the comparative metrics analysis without deviating from the scope of the invention. Exemplary interfaces presenting one or more allocated resource combinations and associated health metrics, resource metrics and economic metrics and comparison of these metrics are explained in detail in conjunction with FIGS. 4-10. The user can analyze the comparative metrics analysis presented to determine an optimal resource combination that can serve the needs of the people in the region.

Even though a comparative analysis of metrics associated with each resource combination is presented to the user, a measurable value indicative of the effects of the comparative analyzes may be helpful to the user for determining the optimal resource combination. To this end, in an embodiment the at least one processor may compute a sustainability score associated with each resource combination. The sustainability score may be computed based on the one or more health metrics, the one or more economic metrics and the one or more resource metrics associated with each resource combination. A sustainability score of a resource combination indicates a forecasted health level achieved for the people when the resource combination is allocated in the location. The sustainability score may be for example a numerical value. The sustainability score may be presented to the user by the computing system 200. The sustainability score associated with each resource combination assist the user to identify the optimal resource combination. The sustainability score may be affected by various health parameters and demographic parameters of the multiple health parameters and the multiple demographic parameters respectively. The health parameters may include but are not limited to mortality, disease incidence, disease prevalence, disability and provider to patient ratio. The demographic parameters may include but are not limited to income, productivity and GDP. The computing system 200 is herein described as used for managing an infrastructure for healthcare in accordance with an embodiment of the invention. However the computing system 200 can be utilized for allocation of resources in a virtual environment for predicting the outcomes before setting up infrastructure for any other purpose without deviating from the scope of the invention.

Turning now to FIG. 3 illustrating a system 300 for managing an infrastructure in a virtual modeling platform in accordance with an embodiment. The system 300 includes a virtual environment 302, a virtual environment generator 304, a resource allocator 306, a user interface 308 and a comparator engine 310. The virtual environment 302 comprises multiple agents in a location. The multiple agents represent a number of people present in a location where the infrastructure for healthcare may need to be established. The location may be represented as a virtual region in the virtual environment 302. The virtual environment 302 thus provides an agent based platform. The virtual environment 302 may be generated by the virtual environment generator 304. In an embodiment the virtual environment generator 304 may receive multiple parameters such as, multiple demographic parameters and multiple health parameters associated with the multiple agents and the location, and characteristics of the number of people. The multiple demographic parameters and the multiple health parameters and the characteristics enable the virtual environment generator 304 to create the virtual environment 302. Thus the location having the multiple agents created may be similar to the location inhabiting the people. In an embodiment, the multiple parameters and the characteristics may be received from the user or data sources known in the art. In another scenario, the multiple parameters and the characteristics may be pre-stored in the system 300.

In the virtual environment 302, multiple resources need to be allocated in the location to establish the infrastructure for healthcare. To this end, the resource allocator 306 dynamically allocates the multiple resources. The multiple resources are similar to the multiple resources explained in detail in conjunction with FIG. 2. The multiple resources may be allocated based on user inputs. The user inputs may be received through the user interface 308. The multiple resources may be selected from a set of resources pre-stored in the system 300. The set of resources may be represented as objects within the virtual environment 302. The user may randomly decide on the number and types of resources that can be allocated in the location. In an embodiment, the resource allocator 306 may enable the user to vary the number of resources and different types of resources that are allocated. In this scenario, one or more resource combinations may be defined by the resource allocator 306. Each resource combination includes one or more resources of the multiple resources allocated in the location. For example, a user may allocate a resource combination that includes two hospitals, hundred beds, ten doctors and a power grid from a location. Thereafter, the user may decide on allocating another resource combination including three hospitals, two hundred beds, twenty doctors, ten healthcare equipments, a power grid and a power generator in the same location within a virtual environment. Thus each resource combination is different from another resource combination.

Explaining by way of a non-limiting example, a user interface may show a location within a virtual environment where healthcare infrastructure needs to be established. A user may select different types of resources such as, hospitals, healthcare equipments, beds, doctors, health experts and allocate in various regions in the location. The resources may be presented as virtual objects in the virtual environment. The user may select the resources from a set of resources presented as a menu of resources in the user interface. The user may select resources from the menu to define two different resource combinations. Alternatively, the user may drag and drop the resources in various regions for allocating the resources. Each resource combination may be allocated within the location at two different instances. For example a first resource combination may be allocated in the location initially and thereafter a second resource combination may be allocated for determining an optimal resource combination.

Based on the multiple resources allocated, the comparator engine 310 determines multiple metrics that indicate a level to which the multiple resources may satisfy the needs of the number of people. Thus the multiple metrics facilitate in managing the infrastructure for healthcare in the location. The multiple metrics include multiple health metrics associated with the multiple agents, the multiple resource metrics and the multiple economic metrics. The multiple health metrics, the multiple resource metrics and the multiple economic metrics are explained in detail in conjunction with FIG. 2. Now when allocation of the multiple resources involves allocating the one or more resource combinations, the comparator engine 310 determines one or more health metrics, one or more resource metrics and one or more economic metrics associated with each of the one or more resource combinations. In an embodiment the one or more health metrics, the one or more resource metrics and the one or more economic metrics are determined over a predefined time period. The predefined period may be defined by the user. The predefined time period when defined facilitates the system 300 to forecast or predict the outcome of allocating the one or more resource combinations in the location for this period.

The comparator engine 310 then compares one or more health metrics, one or more resource metrics and one or more economic metrics associated with each resource combination with one or more health metrics, one or more resource metrics and one or more economic metrics associated with another resource combination. This comparative analysis between resource combinations over the predefined time period may be depicted in the form of graphs or any other manner that enables the user to conveniently view forecast results to determine an optimal resource combination. This optimal resource combination may be then used for establishing the infrastructure for healthcare. Further in an embodiment, the comparator engine 310 may compute a sustainability score associated with each resource combination based on the one or more health metrics, the one or more resource metrics and the one or more economic metrics associated with the each resource combination. The sustainability score may indicate a level of satisfaction of health needs of the number of people in the location.

In a non-limiting example, a first resource combination and a second resource combination may be allocated in a location by the user and a period of 15 years may be defined for forecasting the outcome. The comparator engine 310 may determine a health metric such as an all-cause mortality rate, a resource metric such as number of jobs created, and an economic metric such as investment cost, ROI, associated with the first resource combination and the second resource combination. The comparator engine 310 may then compare these metrics of the first resource combination and the second resource combination and then illustrate the comparison in the form of graphs. These graphs depict forecasted results for a period of 15 years. These forecasted results enable the user to determine an optimal resource combination. Further a sustainability score in the form of a numerical value may be determined for each resource combination and presented to the user. The higher a sustainability score associated with a resource combination indicates that the resource combination is an optimal resource combination. The optimal resource combination identified may have acceptable associated metrics that can be implemented to set up healthcare infrastructure in the location. The system 300 is herein described as used for managing an infrastructure for healthcare in accordance with an embodiment of the invention. However the system 300 can be utilized for allocation of resources in a virtual environment for predicting the outcomes before setting up infrastructure for any other purpose without deviating from the scope of the invention. The system 300 needs to provide an interactive user interface to the user for allocating the resources in the location and then predicting the results based on the allocated resources.

An exemplary user interface 400 for managing an infrastructure using a virtual modeling platform is illustrated in FIG. 4. As shown in FIG. 4, the user interface 400 shows a virtual map 402 of a location such as, a virtual map of India. The user interface 400 enables the user to zoom in and out of the virtual map 402. Thus the user can zoom into a particular region such as a state within the virtual map 402. The virtual map 402 enables a user to identify regions within the place where resources can be allocated.

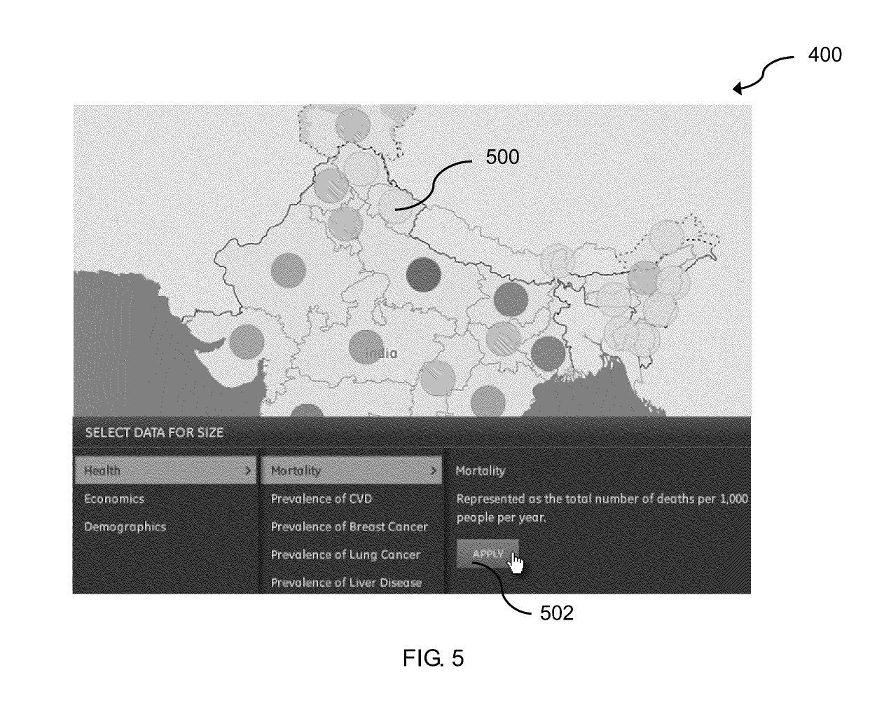

Before allocating the resources the user needs to select multiple demographic parameters and multiple economic parameters associated with the location. These parameters may be pre-stored. The user interface 400 presents a parameter menu 404 to the user as shown in FIG. 4. The parameter menu 404 includes the multiple parameters. The user can select required parameters from the parameter menu 404. For example, in case a user selects a demographics parameter then a sub-menu 406 including various demographic parameters such as, population density, age, income, productivity and DALYs are shown to the user. The user can select the population density as an interested parameter and then select an apply icon 408 to apply this demographic parameter. Similarly, the user can select any other parameters such as, age, income, productivity and DALYs. Once the user selects the apply icon 408, then the selected demographic parameter is displayed in the virtual map 402. The selected demographic parameter such as the population density in a region (e.g. state) may be presented in different forms. For example, the population density in a state may be shown using a circle such as circle 500 as shown in FIG. 5. The population density may indicate the number of people in units if 1000 per square mile. A color of the circle may indicate the population density in the region. So if the color of the circle presented in a region is intense then it indicates that the population density is high in the region. Whereas a circle with less intense color indicates that the population density is less. However, any other techniques may be used for presenting each demographic parameter in the virtual map 402 without deviating from the scope of this invention. In an embodiment the user interface 400 may enable the user to define how the demographic parameter can be presented.

Similarly the user may be able to select a health parameter such as, mortality, prevalence of Cardio Vascular Disease, prevalence of breast cancer, prevalence of lung cancer and prevalence of liver disease from the user interface 400 to apply the health parameter in the virtual map 402. As shown in FIG. 5, the health parameter such as mortality or mortality rate may be selected by the user. The user selects mortality and applies this health parameter using an apply icon 502. The mortality may represent total number of deaths per 1000 people per year in each region. The mortality in each region may be depicted by size of the circles showing the population density. Thus a circle having larger size and intense color may indicate that the mortality and the population density respectively are high in the region. Whereas a circle having smaller size and less intense color indicates that the mortality and the population density respectively are low in the region. In an embodiment a population density and a mortality may be presented using separate circles or in any other convenient manner. In a similar manner the user interface 400 may enable the user to select and vary how the economic parameter can be presented.

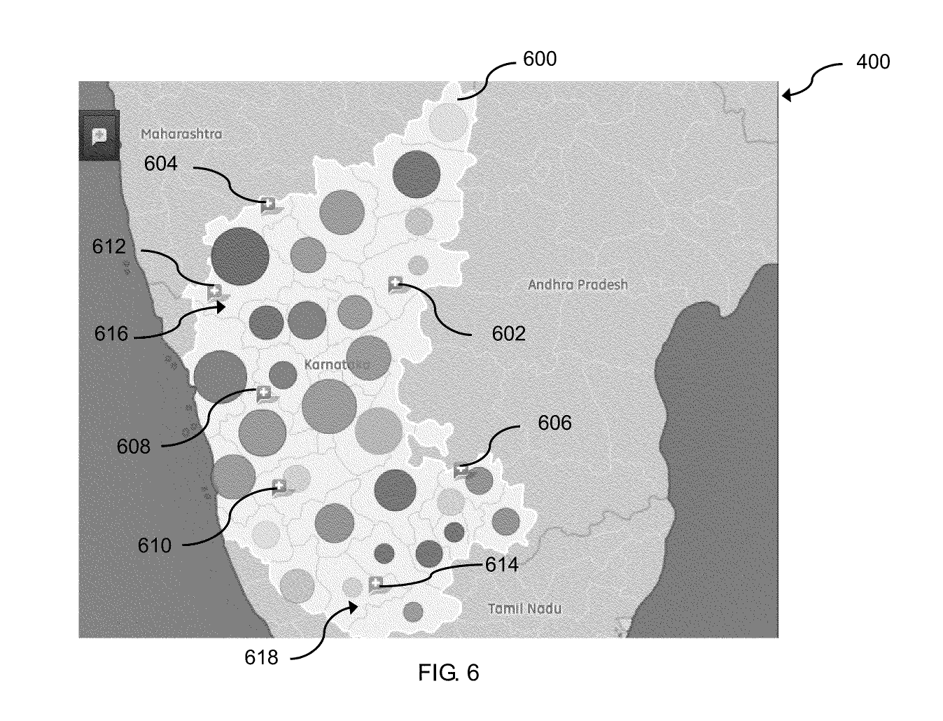

The exemplary user interface 400 shown in FIG. 6 presents population density and mortality rate in a region 600 such as, a Karnataka state within the virtual map 402. The user can select other demographic parameters, health parameters and economic parameters from the plurality of demographic parameters. These parameters may be displayed in the user interface 400 in any manner without deviating from the scope of the invention. Once the required parameters are applied to the virtual map 402, the user may allocate resources in the region. As shown in FIG. 6, one or more health resources are allocated within the region 600. The region 600 shows some health resources such as, a set of resources 602, a set of resources 604, a set of resources 606, a set of resources 608 and a set of resources 610 present currently. These sets of resources are part of already existing healthcare infrastructure in the region. The information regarding these existing sets of resources may be pre-stored in the system. A set of resources such as, the set of resources 602 may be a hospital including healthcare equipments, beds, doctors and other health experts. The user may allocate other health resources in other locations within the region 600 in the virtual map 402. The user may allocate a set of resources 612 and a set of resources 614 in a location 616 and a location 618 respectively within the region 600. The set of resources 610 and the set of resources 612 form a resource combination for example, a first resource combination.

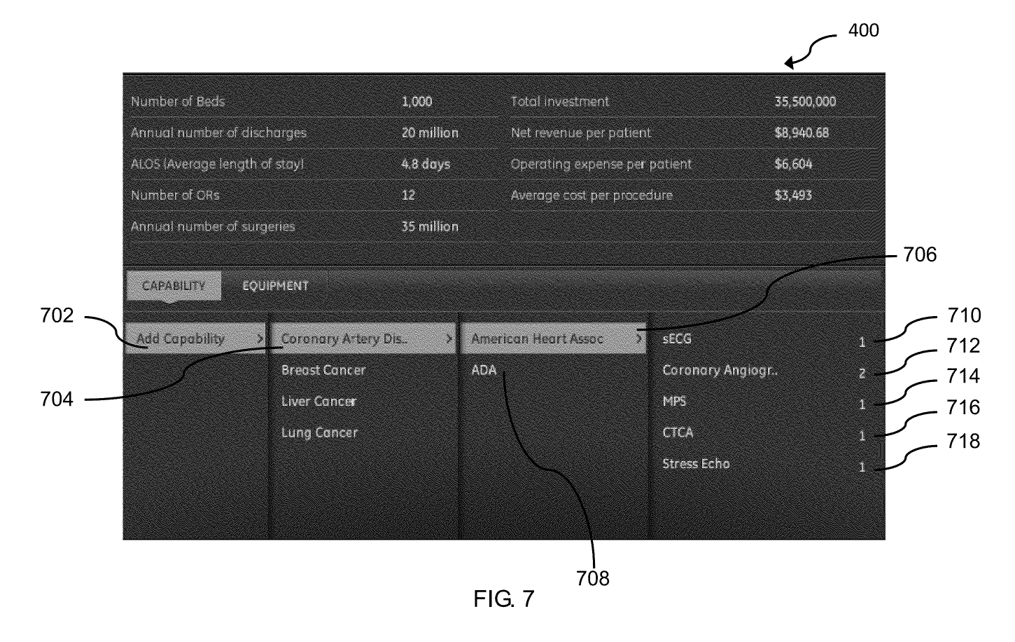

The set of resources 612 and the set of resources 614 may be defined by the user through the user interface 400. The set of resources 612 may be different from the set of resources 614. The set of resources 612 may be defined considering the capabilities required for satisfying certain needs for example, treating some diseases. The user may access a capability menu 702 for defining capabilities. The capability menu 702 may include multiple capability tabs associated with diseases such as, Coronary Artery Disease (CVD), breast cancer, liver cancer and lung cancer as shown in FIG. 7. Each capability tab may include different options that may be arranged in various levels. For example, a CVD capability tab 704 once selected by the user from the capability menu 702 expands to show a first level of options. These options may include American Heart Association tab 706 and an American Diabetes Association (ADA) tab 708. When the user selects the American Heart Association tab 706, then a second level of options may be displayed. The second level of options may include an electrocardiography (sECG) tab 710, a Coronary Angiography tab 712, a myocardial perfusion scintigraphy (MPS) tab 714, Cancer Treatment Centers of America (CTCA) tab 716 and a Stress Echocardiogram tab 718. These different levels of options enable the user to define the capabilities associated with a set of resources such as, the set of resources 612 in a specific manner. As explained in this non-limiting example, a CVD capability associated with the set of resources 612 may be made specific by defining that the set of resources 612 uses measuring standards and other standards defined by the American Heart Association. The capability can be further made specific by defining various equipments such as, sECG, Coronary Angiography, MPS, CTCA and Stress Echocardiogram approved by the American Heart Association.

The user can select a number of equipments. Thus the user interface 400 may enable the user to specify number of equipments that are needed for example, number of equipments required for developing the CVD capability of the set of resources 612. This number may be manually entered by the user. However the user interface 400 may provide any other mechanism for specifying the number of equipments. As shown in FIG. 7, the user may allocate one equipment each for sECG, MPS, CTCA and Stress Echocardiogram and two equipments for Coronary Angiography to define the set of resources 610. Thus the user interface 400 enables the user to conveniently navigate for defining and allocating the resources.

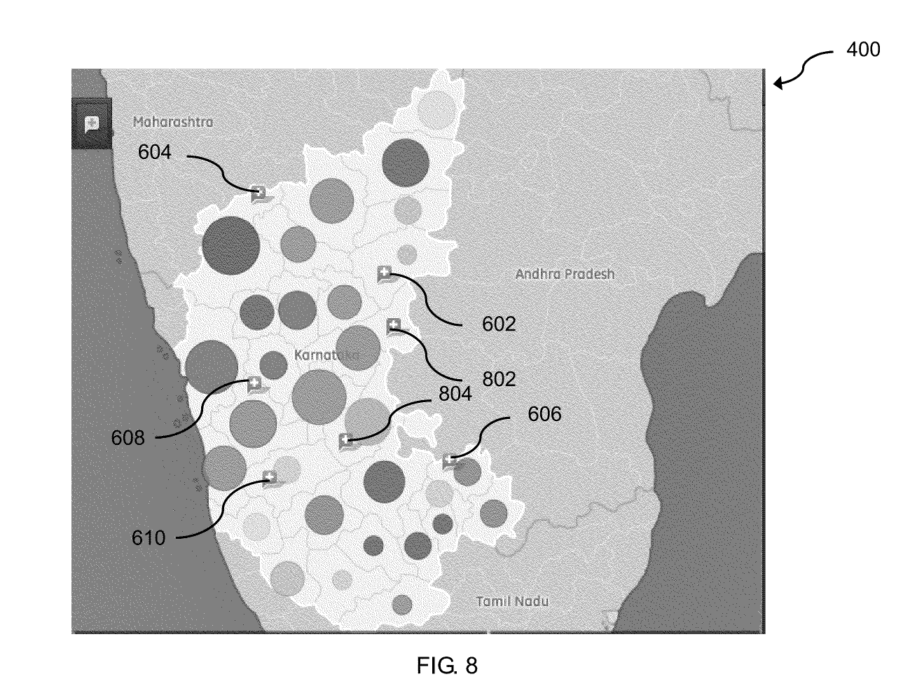

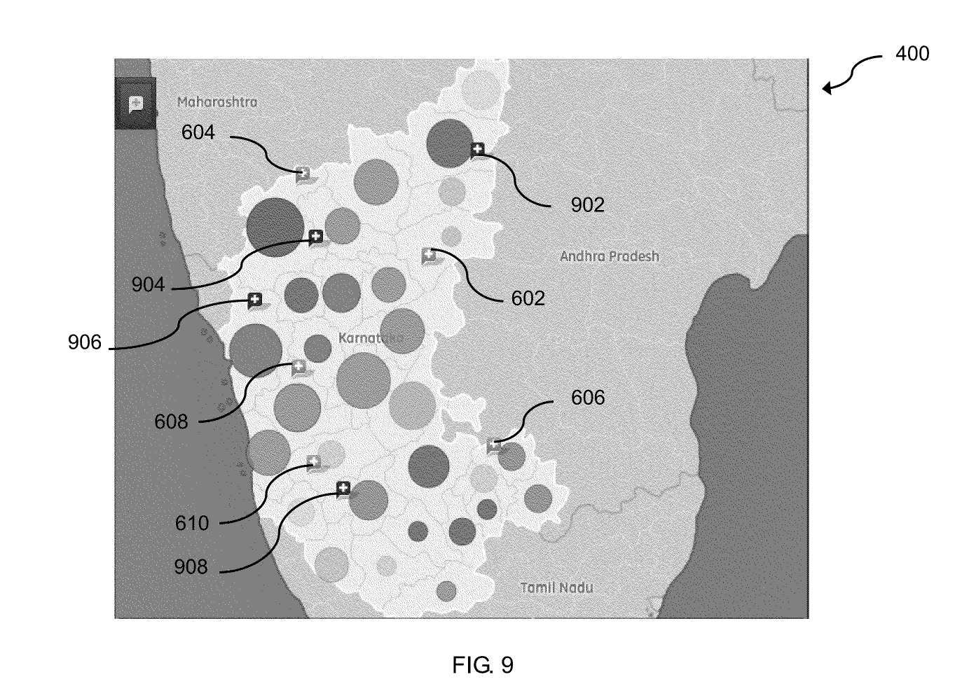

Further as shown in FIG. 7 the user interface 400 also shows the number of beds present in the set of resources 612. The number of beds may be defined by the user. Once the set of resources 612 is defined, the user interface 400 processes the set of resources 612 and displays multiple health metrics, multiple resource metrics and multiple economic metrics. The multiple health metrics include annual number of discharges, Average Length of Stay (ALOS) of a patient, number of surgeries and number of oral re-hydrations. The multiple economic parameters may include total investment required for the set of resources 612, net revenue per patient, operating expense per patient, and average cost per procedure. Similarly the user may be able to define the set of resources 614. The user interface 400 enables the user to define other resource combinations. For example a second resource combination and a third resource combination may be defined by the user as shown in FIG. 8 and FIG. 9 respectively. The second resource combination may include a set of resources 802 and a set of resources 804. The set of resources 802 and the set of resources 804 may be allocated in different locations as compared to the set of resources 612 and the set of resources 614. The third resource combinations include a set of resources 902, a set of resources 904, a set of resources 906 and a set of resources 908 allocated in different locations.

The user interface 400 enables the user to define a predefined time period over which the comparative analysis of metrics associated with these three resource combinations may be performed. In an embodiment, the user interface 400 may provide a sliding feature including a sliding cursor that may be moved by the user to define the predefined time period. However the user interface 400 may enable the user to define the predefined time period in any other manner without deviating from the scope of this invention. The predefined period may be 20 years.

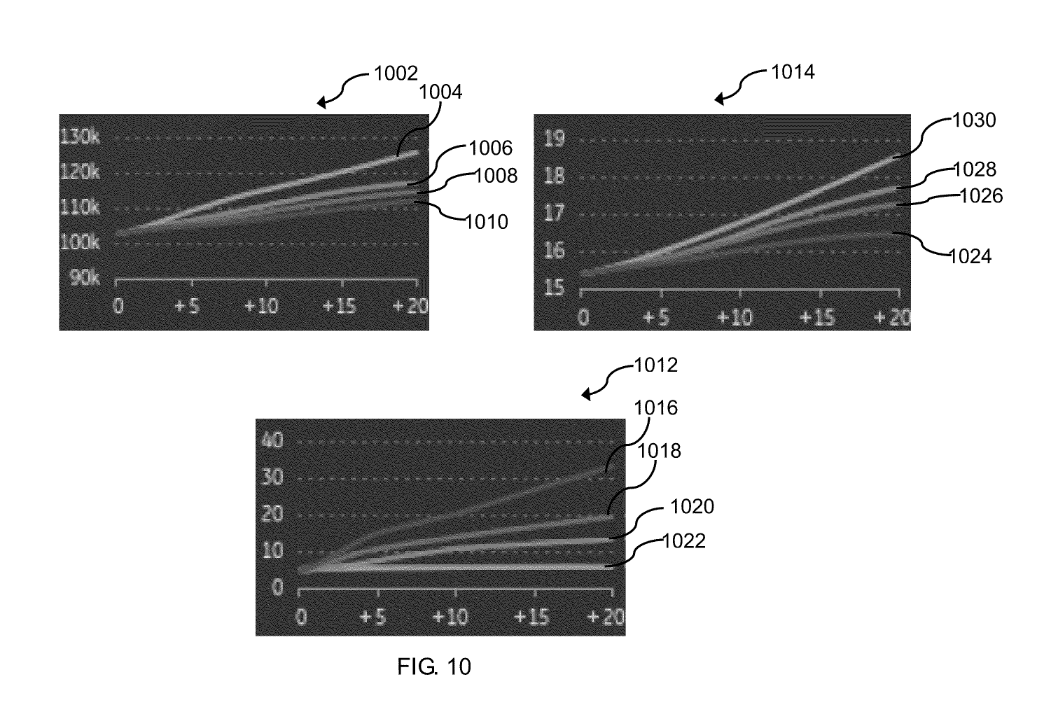

These three resource combinations allocated to the region 600 may be analyzed or simulated to determine multiple health metrics, multiple resource metrics and multiple economic metrics. Then a comparative analysis of the metrics may be performed for each resource combination over the predefined time period and presented in the form of graphs as shown in FIG. 10. FIG. 10 illustrates exemplary graphs showing comparative analysis of the various resource combinations with respect to three health metrics such as, all-cause mortality rate, disability and patient to health expert ratio over a period of 20 years. However it may be envisioned that the user interface 400 may be able to depict graphs associated with other health metrics. Considering a graph 1002 of all-cause mortality rate presenting four line graphs, a line graph may indicate variation in the mortality rate over a period of 20 years for a resource combination. In this graph 1002 X-axis indicates time period for which the forecast is performed and Y-axis indicates the mortality rate value in terms of number of people. The four line graphs indicate the variation in mortality rate for three resource combinations defined by the user and a set of resource combination currently existing in the region 600. Thus the graph 1002 enables a user to identify a resource combination that reduces the mortality rate in the region 600. For example, a line graph 1004, a line graph 1006, a line graph 1008 and a line graph 1010 may be associated with an existing resource combination, a first resource combination, a second resource combination and a third resource combination respectively. Thus based on these line graphs the third resource combination can be identified as reducing the mortality rate for the period of 20 years.

Similarly comparative analysis of other health metrics, resource metrics and the economic metrics for these resource combinations may be presented in the form of graphs through the user interface 400. A graph 1012 and a graph 1014 show a comparative analysis of these resource combinations with respect to health metric disability and patient to doctor ratio respectively. In the graph 1012 the X-axis represents the time period for which the forecast is performed and Y-axis represents a disability rate value in terms of number of people. Furthermore in the graph 1014 the X-axis represents the time period for which the forecast is performed and Y-axis represents a patient to doctor ratio value. The patient to doctor ratio value may be indicative of number of doctors present to attend a predetermined numbers of patients in a location.

For example the graph 1012 depicts a line graph 1016, a line graph 1018, a line graph 1020 and a line graph 1022 that may be associated with an existing resource combination, a first resource combination, a second resource combination and a third resource combination respectively. As shown in the graph 1012, the third resource combination can be identified as reducing the disability rate for the period of 20 years. Furthermore the graph 1014 depicts a line graph 1024, a line graph 1026, a line graph 1028 and a line graph 1030 that may be associated with an existing resource combination, a first resource combination, a second resource combination and a third resource combination respectively. The graph 1014 indicates that the third resource combination represented by the line graph 1030 increases the patient to doctor ratio during the period of 20 years. Thus the user is able to select the third resource combination for deployment. The third resource combination provides the resources required for reducing the mortality rate and the disability rate and increasing the patient to doctor ratio. This improves the quality of life of the population in the location. The graphs presented by the user interface 400 are simple and understandable to the user thereby enabling the user to analyze the forecast results with ease. The user interface 400 may also show a sustainability score associated with each resource combination based on these comparative analysis. The sustainability score as explained in detail in conjunction with FIG. 2 and FIG. 3 indicates the level to which the healthcare needs in the region 600 may be satisfied. Thus these graphs and the sustainability score enables the user to identify an optimal resource combination that can be used for setting up an infrastructure for satisfying the healthcare needs of a number of people in a region such as, the region 600.

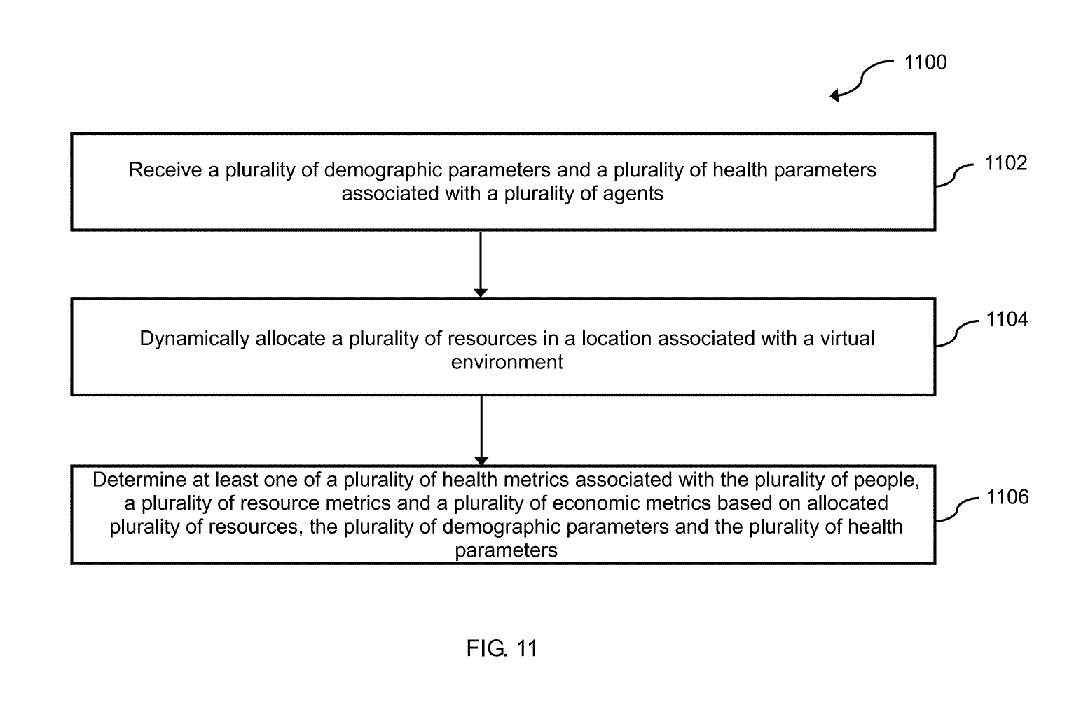

Now turning to FIG. 11 illustrating a flowchart of a method 1100 of managing an infrastructure in a virtual modeling platform in accordance with an embodiment. In this method 1100 initially at block 1102 multiple demographic parameters and multiple health parameters associated with a location in a virtual environment are received. The virtual environment comprises multiple agents in a location. The multiple agents represent a number of people present in a location. Thereafter multiple resources are allocated in the location at block 1104. The multiple resources may be associated with healthcare. In an embodiment the multiple resources may be allocated as one or more resource combinations. Each resource combination includes one or more resources of the multiple resources. One or more of multiple health metrics associated with a number of people, multiple resource metrics and multiple economic metrics are determined based on the allocated resources, the multiple demographic parameters and the multiple health parameters at block 1106. These metrics may be used for identifying an optimal resource from the multiple resources. The multiple health metrics, the multiple resource metrics and the multiple economic metrics facilitate in managing the infrastructure for healthcare in the location. The infrastructure may be established using the optimal resource combination.

Thus, certain examples provide a model, simulation engine, and associated tools to assist governments and private investors with the planning of infrastructure projects such as hospitals, energy, and clean water. The model provides a user-friendly interface including an interactive map of a country, region, city or other location. Users can drag and drop icons representing hospitals, energy, or water treatment facilities onto the map, for example. The model uses pre-programmed data and a series of equations to calculate and project several metrics. Examples of these metrics include cost, income distribution, productivity, return-on-investment, mortality, and disease prevalence. Investors and public decision-makers can then decide where to locate new facilities, how much to invest, and what the projected benefits will be. A deeper level of interactivity is available for more sophisticated users and more specialized questions. For example, with a hospital delivering cardiac services, it is possible to specify the number and type of imaging equipment available, the order in which patients receive tests, the accuracy of each test, the number of patients treated based on the surrounding demographics, and the projected patient outcomes related to cardiology.

Certain examples enable a user to compare different types of hospital services (e.g., cardiology, oncology, primary care, etc.). Certain examples enable users to compare different amounts of hospital services to determine optimal mix (e.g., forecasting the effects of having two cardiac centers plus one oncology center plus four primary care centers in a given region). Certain examples enable users to compare different types of infrastructure investments (e.g., healthcare, energy, water, etc.). Certain examples enable users to compare different amounts of infrastructure investments (e.g., forecast the effects of having three hospitals plus one nuclear power plant plus two water treatment facilities in a given region).

In certain examples, population data for a location (e.g., a target country such as India, etc.) is preloaded. For example, population density, income, mortality, disease prevalence, etc., for a location can be preloaded into the model for simulation. Additionally, advanced modeling enables users to forecast effect(s) of treating multiple diseases. Multiple infrastructure projects can be supported. In certain examples, multiple metrics of interest to public and private decision-makers (e.g., economic and health metrics) are displayed in conjunction with the model.

In certain examples, utilizing gaming technology for the user-interface creates an engaging and intuitive experience. The complexity of integrating large datasets and modeling calculations is solved by the user interface. In addition, the user is able to overlay multiple heat maps to demonstrate metrics of interest for a selected location. For example, the user can select population density and view a heat map of the varying concentrations of population across the region. Then, the user can overlay a second heat map (e.g., in a different color) that demonstrates the varying prevalence of disease burden across the region.

In certain examples, the modeling, mapping, and simulation platform can be provided as a cloud-computing environment that accommodates historical and/or real-time, continuous patient, resource, and/or environmental data from a plurality of sources such as electronic medical records, enterprise archives, public databases, remote monitoring devices, etc.

Using “big data” (e.g., a collection of data sets so large and complex that it becomes difficult to process using on-hand database management tools or traditional data processing applications) for a country or other region as much as possible enables a business developer to provide “company to country” solutions that improve population metrics. Holistic economic and health benefits that accrue to a population as a result of different types of infrastructure investments can be modeled or analyzed.

Via the interactive map provided with the model, a user can heat map data points of interest. A user can also map out other variables (e.g., a number of people living in an area, a number of people afflicted by a particular disease, etc.). The map can zoom into a particular state and drill in deeper to a level of information such as state, district, etc.

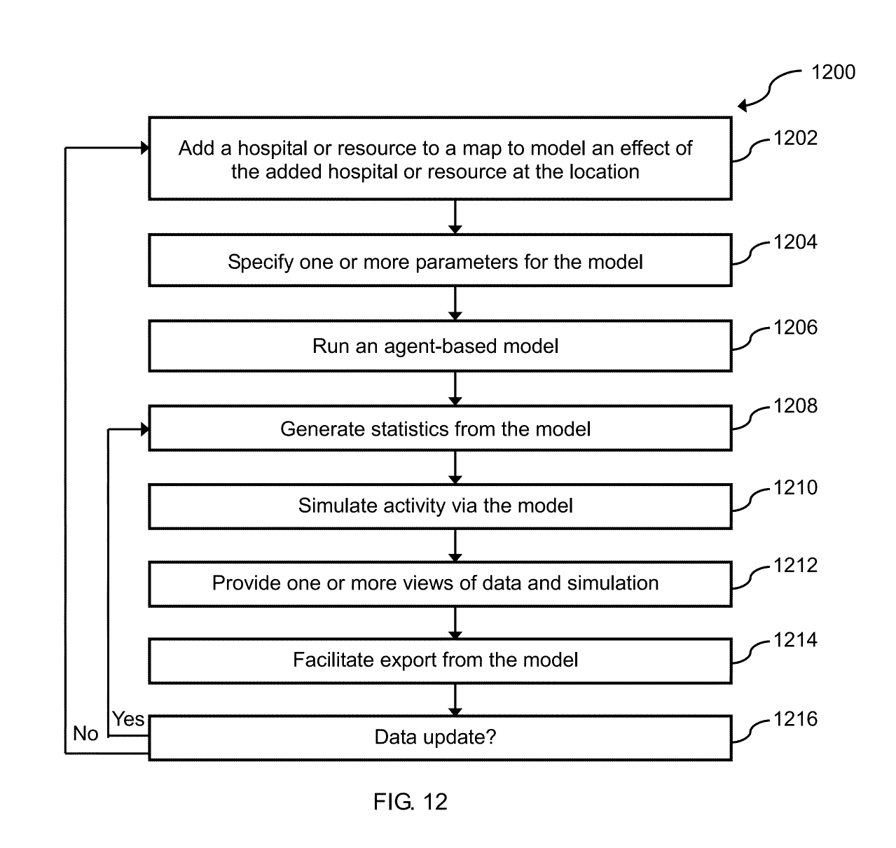

Using information in association with the map, the model provides a visualization of availability of hospitals throughout a district and can help identify a candidate district to build a new hospital. FIG. 12 illustrates a flowchart of a method 1200 of virtual modeling of one or more resources at a location in accordance with an embodiment. At block 1202, a hospital or other resource can be added or edited at a location on the map to evaluate a projected effect of the hospital or other resource on the local population.

At block 1204, one or more parameters associated with the hospital or other resource are specified for the model. For example, a size (such as a predefined size or custom size), a date of operation, a population served, etc., can be specified for the hospital or other resource. Treatment capabilities, diagnostic guidelines, etc., can be specified for the hospital or other resource, for example.

At block 1206, the model can be run for the selected hospital and/or other resource. Crude estimates in the model can be aligned to the size of the hospital, for example. The hospital can be modeled with certain equipment within bounds of a specified geography and draws from population data, for example. The model can be provided using geographic information systems (GIS) combined with maps, such as GOOGLE® maps.

In certain examples, an agent-based model is used to model potential outcome(s) and/or associated data. An agent-based model (ABM) (also sometimes related to as a term multi-agent system or multi-agent simulation) is a class of computational models for simulating the actions and interactions of autonomous agents (e.g., individual and/or collective entities such as organizations or groups) to assess their effects on the system as a whole. In certain examples, agent-based modeling combines elements of game theory, complex systems, emergence, computational sociology, multi-agent systems, and evolutionary programming. In certain examples, Monte Carlo methods are used to introduce randomness.

The agent-based model simulates simultaneous operations and interactions of multiple agents, in an attempt to re-create and predict the appearance of complex phenomena. In certain examples, individual agents are characterized as boundedly rational, presumed to be acting in what they perceive as their own interests, such as reproduction, economic benefit, or social status, using heuristics or simple decision-making rules. ABM agents may experience “learning”, adaptation, and changes in health, for example.

In certain examples, an agent-based model includes (1) a plurality of agents specified at various scales (e.g., referred to as agent-granularity); (2) decision-making heuristics; (3) learning rules or adaptive processes; (4) an interaction topology; and (5) a non-agent environment. A simulation of a population of a selected area can include a plurality of agents functioning as avatars or virtual people in support of the model and associated analytics, for example.

At block 1208, statistics are generated from the agent-based, predictive model. Statistics such as modality utilization rate, ROI for the hospital, number of jobs created, etc. Data such as demographic data, socio-economic data, clinical data, etc., can be used to form the model and generate statistics as well as generate trends and big data forecasting via agent-based modeling. Graphs, such as an economic cost graph, etc., can be populated with modeled data for the population for example.

At block 1210, activity is simulated via the agent-based, predictive model. Activity in the location based on the added hospital or other resource can be simulated and verified during simulation, for example. Modeled agents can be created as digital constructs or clones of digital people rather than unstructured medical services data, for example. Data, such as patient information, demand, utilization, etc., can be uploaded periodically, continuously, in real time, etc.

At block 1212, one or more views of the data and simulation are provided to a user. For example, a timeline view can be displayed to show a change in statistics, activity, etc., over time. A summary view can be provided to illustrate a snapshot of available data. A full instant view can be provided to give a complete picture of a current simulated model. Views can be provided at the population level, hospital/resource level, group level, etc. In certain examples, information such as hospital occupancy data, treatment data, cost data, ROI data, resource utilization data, mortality data, readmission data, etc., can be provided to a user.

In certain examples, in addition to providing digital clones of human beings and accommodating avatars of real people receiving uploaded data, the modeling and simulation platform provides a forecasting tool, as well as a retrospective analysis. As more data is added and more simulations are done, the forecasting tool is able to improve in accuracy, precision, scope, etc. The resource and/or policy forecasting tool provided gets better and more precise at forecasting because more immediate and more precise data is being fed into the system, for example.

In addition to disease states, certain examples provide more comprehensive healthcare organization modeling. Hot spots for infectious disease can be identified and/or predicted, as well as projecting where a disease is going and what should/could be done to contain it. Other environmental qualities, such as water quality, can be viewed to see how water quality is changing in a district over time, for example.

At block 1214, data can be exported from the model. For example, a spreadsheet, presentation slides, and/or other document can be generated to show the model, map, statistics, activity report(s), etc. Simulation output can be provided in a pre-populated report, for example. In certain examples, output can be exported to another application for reporting, analytics, storage, clinical decision support, etc.

At block 1216, a data update is identified. For example, a real time (or substantially real time accounting for data transmission and/or processing delays) data feed can be provided from one or more external inputs. The “real time” or other dynamic data feed can provide updated actual or “real life” data from the target location and/or associated population into the model. For example, one or more remote monitoring devices providing locational data for one or more parameters can feed into the modeling/simulation system. Parameters include patient blood pressure, blood sugar, blood hemoglobin, heart rate, water quality (e.g., total suspended particles in water), electrocardiogram data, body temperature, urine protein test, urine sugar test, etc.

Thus, in certain examples, “real time, continuous” patient data can be provided from remote monitoring devices to feed the model and associated map and simulation. In certain examples, “real time, continuous” equipment and/or other resource data can be provided and updated in the system (e.g., hospital resource allocation, usage, availability, maintenance status, etc.). For example, real-time and continuous performance data from hospital equipment, such as scan time, radiation dose, and maintenance monitoring (e.g., equipment in need of maintenance), can be uploaded into the virtual hospitals (“hospital agents”) embedded within the modeling environment. Further updates to power grid availability, power requirements, water supply, other environmental factors, can be provided for input into the model.

If a data update is identified, the, at block 1218, the data update is imported into the model. Statistics (block 1208) and simulated activity (block 1210) can then be updated or regenerated based on imported data. Similarly, one or more views (block 1212) and data export (block 1214) can be facilitated using the updated data from the “real time” data feed or other update of data.

The methods 1100, 1200 can be performed using a processor or any other processing device. The method elements can be implemented using coded instructions (e.g., computer readable instructions) stored on a tangible computer readable medium. The tangible computer readable medium may be for example a flash memory, a read-only memory (ROM), a random access memory (RAM), any other computer readable storage medium and any storage media. Although the method of managing an infrastructure in a virtual environment is explained with reference to the flow chart of FIG. 11, other approaches to implement the method 1100 can be employed. Similarly, although the method of virtual modeling of one or more resources at a location is explained with reference to the flow chart of FIG. 12, other approaches to implement the method 1200 can be employed. For example, the order of execution of each method element may be changed, and/or some of the method elements described may be changed, eliminated, divide or combined. Further the method elements may be sequentially or simultaneously executed for managing an infrastructure in the virtual environment.

As described herein, the methods 1100, 1200 can be implemented in one or more combinations of hardware, software, and/or firmware, for example. The methods 1100, 1200 can operate in conjunction with one or more external systems (e.g., data sources, healthcare information systems (RIS, PACS, CVIS, HIS, etc.), archives, imaging modalities, etc.). One or more components of the methods 1100, 1200 can be reordered, eliminated, and/or repeated based on a particular implementation, for example. The methods 1100, 1200 can be implemented using a stationary (e.g., desktop workstation, laptop computer, etc.) and/or mobile device (e.g., smartphone, tablet computer, etc.), for example.

The example processes described herein can be implemented using coded instructions (e.g., computer readable instructions) stored on a tangible computer readable medium such as a hard disk drive, a flash memory, a read-only memory (“ROM”), a CD, a DVD, a BLU-RAY™, a cache, a random-access memory (“RAM”) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes can be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computing system comprising:
a memory to store a plurality of demographic parameters and a plurality of health parameters associated with a plurality of people in a location; and
a processor configured to:
dynamically allocate a plurality of resources in a region representing the location within a virtual environment, wherein the plurality of resources is associated with an infrastructure for healthcare; and
determine at least one of a plurality of health metrics associated with the plurality of people, a plurality of resource metrics and a plurality of economic metrics based on the allocated plurality of resources.

2. The computing system of claim 1, wherein the processor is to select the plurality of resources from a set of resources based on a user input.

3. The computing system of claim 2, wherein the set of resources comprises at least one of a health care resource, an energy resource and a water resource.

4. The computing system of claim 2, wherein the processor is to:
define at least one resource combination, each resource combination comprising one or more resources of a plurality of resources dynamically allocated in the location, wherein a resource combination is different from another resource combination; and
determine at least one health metric, at least one resource metric and at least one economic metric associated with each of the at least one resource combination.

5. The computing system of claim 4, wherein the processor is to compute a sustainability score associated with each resource combination based on the at least one health metric, the at least one resource metric and the at least one economic metric associated with each resource combination, wherein the sustainability score indicates a health level of the plurality of people.

6. The computing system of claim 4, wherein the processor is to compare a health metric, a resource metric and an economic metric associated with a first resource combination with a health metric, a resource metric and an economic metric associated with a second resource combination.

7. The computing system of claim 1, wherein at least one of the plurality of health metrics, the plurality of resource metrics and the plurality of economic metrics is determined over a predefined time period.

8. A system for managing an infrastructure using a virtual modeling platform, the system comprising:
a virtual environment comprising a plurality of agents in a location, the plurality of agents representing a plurality of people present in a location;
a resource allocator to dynamically allocate a plurality of resources in the location, wherein the plurality of resources is associated with the infrastructure for healthcare; and
a comparator engine to:
receive a plurality of demographic parameters and a plurality of health parameters associated with the plurality of agents in the location; and
determine at least one of a plurality of health metrics associated with the plurality of people, a plurality of resource metrics and a plurality of economic metrics based on the allocated plurality of resources, wherein the plurality of health metrics and the plurality of economic metrics facilitate management of the infrastructure in the location.

9. The system of claim 8, further comprising a virtual environment generator to generate the virtual environment having the plurality of agents based on the plurality of demographic parameters and the plurality of health parameters associated with the plurality of people.

10. The system of claim 8, wherein the resource allocator is to define at least one resource combination, each resource combination comprising one or more resources of the plurality of resources dynamically allocated in the location, wherein a resource combination is different from another resource combination.

11. The system of claim 10, wherein the comparator engine is to determine a health metric, a resource metric and an economic metric associated with each of the at least one resource combination.

12. The system of claim 11, further comprising a user interface to present the health metric, the resource metric and the economic metric associated with each resource combination to a user.

13. The system of claim 11, wherein at least one of the plurality of health metrics, the plurality of resource metrics and the plurality of economic metrics is determined over a predefined time period, wherein the user interface enables the user to define the predefined time period.

14. The system of claim 10, further comprising a user interface to receive user input to define the at least one resource combination.

15. The system of claim 10, wherein the comparator engine is to compute a sustainability score associated with each resource combination based on the health metric, the resource metric and the economic metric associated with each resource combination, wherein the sustainability score indicates a health level of the plurality of agents.

16. The system of claim 10, wherein the comparator engine is to compare a health metric, a resource metric and an economic metric associated with a first resource combination with a health metric, a resource metric and an economic metric associated with a second resource combination.

17. A method of managing an infrastructure using a virtual modeling platform, the method comprising:
receiving a plurality of demographic parameters and a plurality of health parameters associated with a location in a virtual environment, the virtual environment comprising a plurality of agents in a location, the plurality of agents representing a plurality of people present in a location;
dynamically allocating a plurality of resources in the location; and
determining at least one of a plurality of health metrics associated with the plurality of people, a plurality of resource metrics and a plurality of economic metrics based on the allocated plurality of resources, the plurality of demographic parameters and the plurality of health parameters, wherein the plurality of health metrics and the plurality of economic metrics facilitate in managing the infrastructure for healthcare in the location.

18. The method of claim 17, further comprising generating the virtual environment having the plurality of agents based on the plurality of demographic parameters and the plurality of health parameters associated with the plurality of people.

19. The method of claim 17, further comprising:
defining at least one resource combination, each resource combination comprising one or more resources of the plurality of resources dynamically allocated in the location and selected from a set of resources, wherein a resource combination is different from another resource combination;
determining at least one health metric, at least one resource metric and at least one economic metric associated with each of the at least one resource combination; and
comparing at least one health metric, at least one resource metric and at least one economic metric associated with a resource combination with at least one health metric, at least one resource metric and at least one economic metric associated with another resource combination.

20. The method of claim 19, further comprising computing a sustainability score associated with each resource combination based on the at least one health metric, the at least one resource metric and the at least one economic metric associated with each resource combination, wherein the sustainability score indicates a health level of the plurality of agents.
